(19) United States
(12) Patent Application Publication
(10) Pub. No.: US 2017/0258067 A1
(43) Pub. Date: Sep. 14, 2017

(54) TOOL FOR REMOVING SNOW AND ICE BUILDUP FROM HORSE HOOVES

(71) Applicant: Michael Holmes, Kinsale, VA (US)

(72) Inventor: Michael Holmes, Kinsale, VA (US)

(21) Appl. No.: 15/066,524

(22) Filed: Mar. 10, 2016

(51) Int. Cl. A01L 15/00; A01L 11/00; A01K 13/00

(52) U.S. Cl. CPC A01L 15/00; A01K 13/001; A01L 11/00

(57) ABSTRACT

A tool for removing snow and ice from horse hooves is provided. The tool includes a handle to fit into the hand of the user and a head secured to the end of the handle. The head is comprised of a spoon like end for primary debris removal and a hoof pick end for additional debris removal. The spoon like end has a machined edge to facilitate cutting into and breaking up the snow and ice buildup. The rounded shape of the spoonlike end prevents injury to the horse's hoof.

### BACKGROUND OF THE INVENTION

The present invention relates to equine care and, more particularly, to a tool for removing snow and ice buildup from horse hooves.

Snow and ice tend to build up and compact within a horse's hooves when that horse is shod and it walks on snow covered ground. It is necessary to remove this buildup from horse's hooves for horse safety, rider safety and horse comfort. Currently, the standard means of removing snow and ice buildup from horse's hooves is using a hoof pick, which is difficult, cumbersome and can be time consuming. The more time horse's hooves are held off the ground for removal of buildup, the more dangerous it becomes for the horse and rider.

As can be seen, there is a need for an apparatus used to quickly and safely remove snow and ice buildup from horse's hooves.

### SUMMARY OF THE INVENTION

The tool for removing snow and ice from horse hooves comprises: A handle to be held in one hand; a head mounted on the end of the handle. On one end of the head is a head used for impacting on the snow and ice buildup. The opposite end of the head is hoof pick-shaped for residual cleaning of the hooves.

### BRIEF DESCRIPTION OF THE DRAWINGS

FIG. 1 is a top perspective view of an embodiment of the present invention.

FIG. 2 is a bottom perspective view of an embodiment of the present invention.

FIG. 3 is a section view of the present invention taken along line 3 in FIG. 2

FIG. 4. Is a perspective view of an embodiment of the present invention shown in use in relation to a horse's hoof.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a spoonlike metal head affixed to the end of a handle. The present invention is used to clear snow and ice buildup from horse's hooves. The present invention includes a hoof pick-like device opposite the spoonlike end of the metal head.

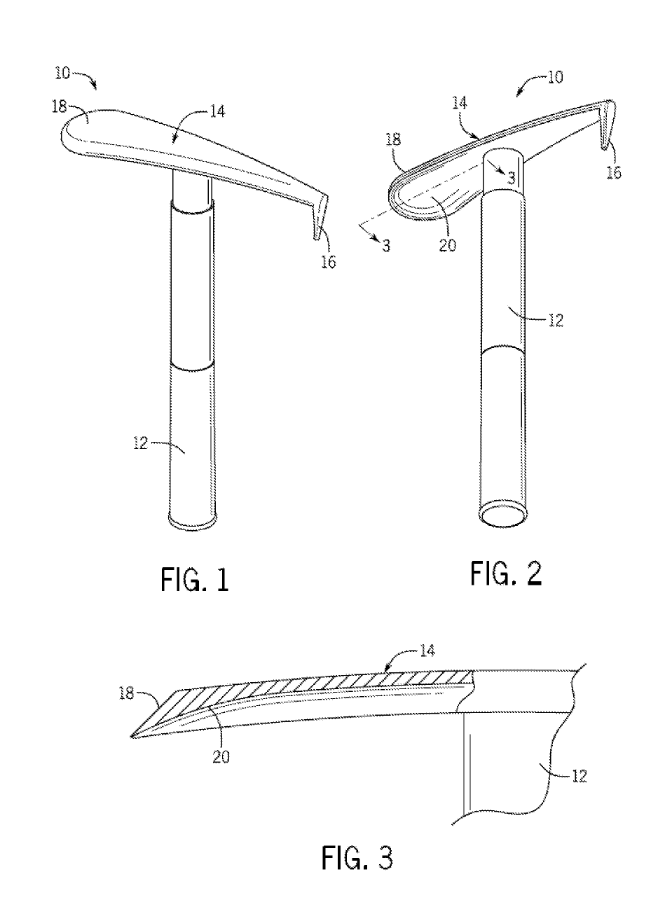

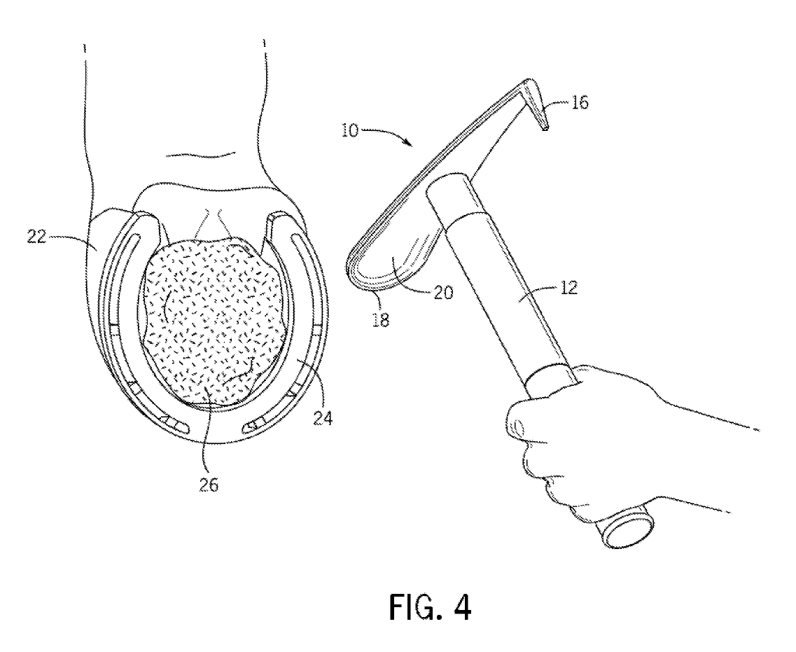

Referring to FIGS. 1 through 4, the present invention includes a tool for removing snow and ice from horse's hooves.

The tool 10 includes a handle 12 designed to fit into the hand of a user, and a head 14. The head 14 is secured to the handle 12. The head 14 is comprised of a hoof pick end 16 and a spoonlike end 18. The spoonlike end 18 has an edge 14 that is designed to cut into the snow and ice buildup and an underside 20 the scoops the snow and ice buildup.

The tool spoonlike edge 18 of the tool 10 is gently swung towards the snow and ice buildup 26 within the horseshoe 24. The edge 14 and spoonlike and 18 strike and scoop the buildup without injuring the horse's hoof 22. The tool 10 can then be turned around to employ the hoof pick end 16 to further fine clean debris 26 from within the horseshoe 24.

It should be understood, of course, that the foregoing relates to exemplary embodiments of the invention and that modifications may be made without departing from the spirit and scope of the invention as set forth in the following claims.

What is claimed is:

1. A tool for removing snow and ice buildup from horses hooves comprising:
A tool with a handle portion and a head portion

2. The tool for removing snow and ice debris of claim 1, further comprising a head with a spoon shaped end for scooping snow and ice buildup.

3. The tool for removing snow and ice debris of claim 2, wherein the spoon shaped end has machined edge for cutting into the snow and ice buildup.

4. The tool for removing snow and ice debris of claim 1, further comprising, opposite the spoon shaped end, a hoof pick end for additional cleaning of debris.
